(19) United States
(12) Patent Application Publication
(10) Pub. No.: US 2007/0290635 A1
(43) Pub. Date: Dec. 20, 2007

(54) Motor controller

(75) Inventor: Yuji Yoshida, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION

(21) Appl. No.: 11/810,467

(22) Filed: Jun. 6, 2007

(30) Foreign Application Priority Data
Jun. 6, 2006 (JP) 2006-157611

(51) Int. Cl. H02P 5/00

(52) U.S. Cl. 318/66

(57) ABSTRACT

A motor controller which controls the driving of a plurality of motors, including for each of the plurality of motors: a motor control block for independently controlling the driving of the respective motors, wherein the respective motor control blocks includes: a storage unit that stores a pulse data value for generating a signal for carrying out drive control of a motor which is connected to this motor control block; and a pulse generator that generates the signal for carrying out drive control of the motor based on pulse data values sequentially transmitted from the storage unit, and outputs same to the motor connected to this motor control block.

### CROSS-REFERENCES TO RELATED APPLICATIONS

The entire disclosure of Japanese Patent Application No. 2006-157611, filed on Jun. 6, 2006, is expressly incorporated by reference herein.

### BACKGROUND

1. Technical Field

The present invention relates to a motor controller, and more particularly to a motor controller, which carries out drive control for a plurality of motors.

2. Related Art

A motor (stepping motor), which is used as a power source for transporting paper and so forth in a printer or the like, and which is controlled by combining phase signals, has been used for some time. Stepping motor control involves using the CPU timing function to create pulse output timing to the stepping motor, and outputting a signal from the CPU to the motor when a timer interrupt is generated. Acceleration/deceleration and constant speed control are implemented by setting this timer setting to the step drive interval of the motor.

However, since this control system requires that the CPU output a signal to the motor at every timer interrupt, it places a load on the CPU, causing trouble for other processes. Further, because processing time is needed until a timer interrupt process starts, precise stepping pulse control is not possible. Accordingly, in the invention disclosed in JP-A-2001-286190, the constitution is such that a DMA controller (Direct Memory Access Controller) function is used to directly transmit a stepping pulse data value to the motor control block from an external memory without going through the CPU to achieve the desired operation.

However, in the invention disclosed in JP-A-2001-286190, every time a control signal is outputted to the motor, a stepping pulse data value stored in an external memory is read to the motor control block by the DMA controller built into the motor control block. Since the external memory is used in common by a plurality of motors, when the plurality of motors operate simultaneously, mediation takes time, and as a result, there is a likelihood of stepping pulse signal output timing deviating from the set value.

Further, since the external memory is of finite length, when an infinite length stepping pulse is to be outputted to the motor, subsequent data is immediately set in the external memory after the data transmission of the DMA controller has ended, requiring the DMA controller to reboot, during which time the drive pulse signal output to the motor is delayed.

### SUMMARY

An advantage of some aspects of the invention is the provision of a motor controller, which enables drive control to be carried out independently for a plurality of motors. Another advantage of some aspects of the invention is the provision of a motor controller, which can simultaneously start and stop the driving of a plurality of motors.

To solve for the above-mentioned problems, a motor controller according to an aspect of the invention is a motor controller which controls the driving of a plurality of motors, comprising, for each of the plurality of motors, a motor control block for independently controlling the driving of the respective motors. Then, the respective motor control blocks comprise storage means for storing a pulse data value for generating a signal for carrying out drive control for a motor connected to the corresponding motor control block; and pulse generating means for generating, based on a pulse data value sequentially transmitted from storage means, a signal for carrying out drive control of a motor and outputting same to the motor connected to the corresponding motor control block. According to an aspect of this invention, one-to-one data storage with a motor, and completely independent driving of a plurality of motors become possible by separately providing in motor control blocks buffers for storing pulse data values.

Further, it is desirable that the plurality of motor control blocks of the motor controller be able to share start/stop means for controlling the drive start and stop of the plurality of motors, and be able to simultaneously control drive start and stop for the plurality of motors. According to an aspect of this invention, it becomes possible to simultaneously realize drive start and stop for a plurality of motors.

Preferentially, storage means is either a ring buffer configuration for linking the beginning and end of a storage array to store and manage data in ring shape, or a double buffer configuration comprising two storage arrays. When a ring buffer configuration is employed, infinite length pulse data can be set. Further, when a double buffer configuration is employed, a pulse data value write to the one storage array is possible while a pulse data value read is being carried out from the other storage array.

Further, storage means preferentially comprises a function for outputting either an empty near end or an end interrupt, and for notifying controlling means of the timing at which storage means becomes empty. Here, controlling means is for controlling the overall operation of the motor controller, and when either the empty near end or end interrupt is received from storage means, a pulse data value rewrite is performed for storage means. Or, storage means comprises a function for reading out an address that is currently being read out, and controlling means rewrites an outputted pulse data value to storage means based on an address received from storage means. According to an aspect of this invention, it is possible to rewrite a pulse data value stored in storage means at an appropriate timing.

Furthermore, preferentially a motor is a stepping motor, and a pulse data value comprises first data which prescribes the states of signals outputted to the respective motors, and second data which prescribes the pulse width of output signals.

Furthermore, in this specification, means does not simply signify physical means, but rather also includes a situation, in which the function of this means is realized via software. Further, the function of one means can be realized by two or more physical means, and the functions of no less than two means can be realized by one physical means.

### BRIEF DESCRIPTION OF THE DRAWINGS

The invention will be described with reference to the accompanying drawings, wherein like numbers reference like elements.

FIG. 1 shows the overall constitution of a motor controller 100.

FIG. 2 shows the constitution of a motor control unit 16.

FIG. 3 shows an example of pulse data values stored in a table buffer 24.

FIG. 4 shows a motor control signal outputted from a pulse generator 22.

### DESCRIPTION OF EXEMPLARY EMBODIMENTS

An embodiment of the invention will be explained in detail hereinbelow while referring to the figures. Furthermore, like numbers reference like components, and duplicate explanations are omitted.

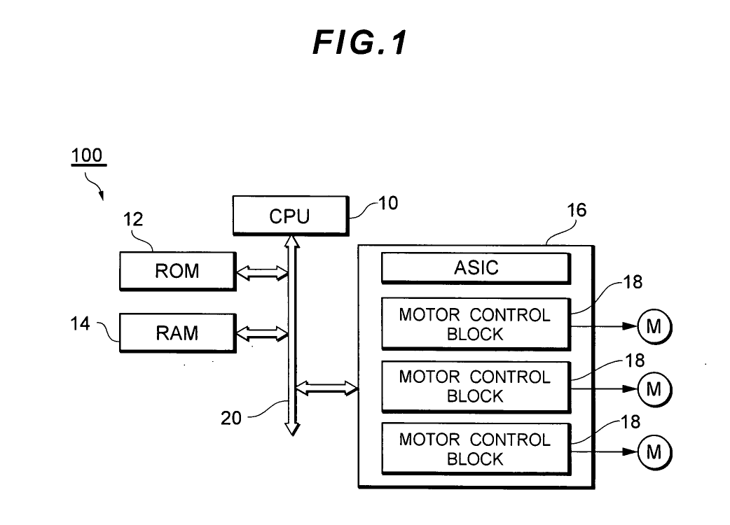

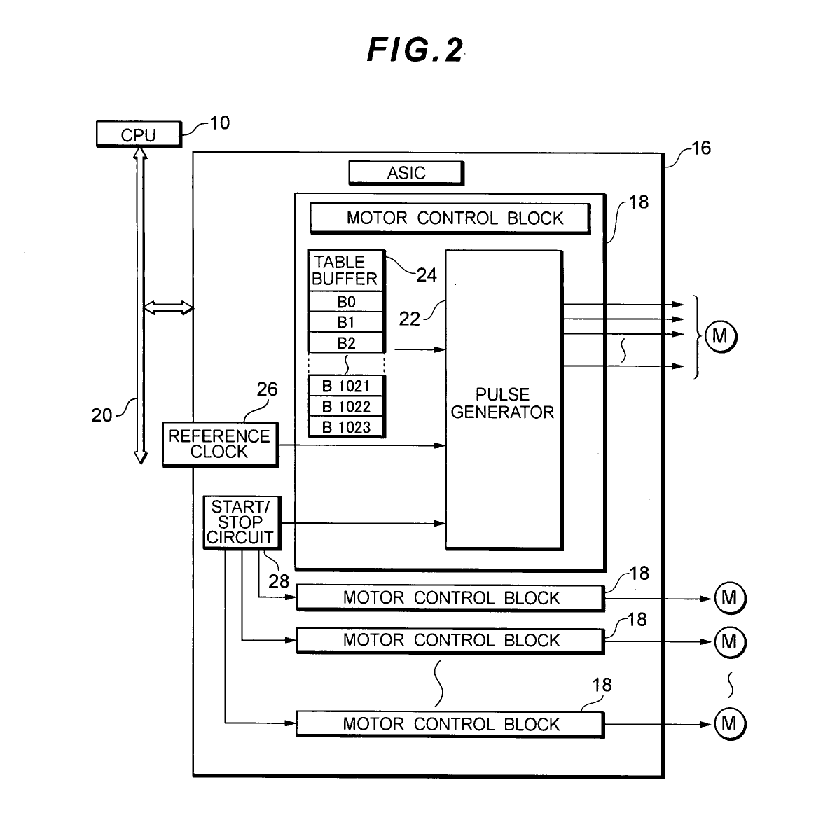

FIG. 1 and FIG. 2 are block diagrams showing examples of system constitutions of a motor controller 100 according to an aspect of the invention. FIG. 1 shows the overall constitution of the motor controller 100. Further, FIG. 2 shows a portion of the motor controller 100, more particularly the constitution of the motor control unit 16.

As shown in FIG. 1, the motor controller 100 in this embodiment is constituted such that a CPU 10, a ROM 12, a RAM 14, and a motor control unit 16 are respectively connected to a bus 20, and a variety of data can be transmitted back and forth therebetween. Further, the motor control unit 16 comprises a plurality of motor control blocks 18, and a motor M is connected to each motor control block 18.

Here, the CPU 10 is controlling means for controlling the overall operation of the motor controller 100, and treats RAM 14 as a work area, executes processing and commands in accordance with programs stored in ROM 12, and carries out drive control of a motor M. Further, the plurality of motors M are stepping motors used as the power sources for feeding paper and the like to a printer, and the respective motors M are subjected to drive control by the respective motor control blocks 18.

Further, the motor control unit 16 is an integrated circuit designed for use in motor control (ASIC), and, as shown in FIG. 2, comprises a plurality of motor control blocks 18 in parallel. Then, each of the plurality of motor control blocks 18 comprises a pulse generator 22 for generating a control signal, which is inputted to a motor M; and a table buffer (RAM) 24, which stores pulse data values for generating a stepping pulse signal for carrying out the drive control of a motor M. Furthermore, a portion of the drawing is omitted in FIG. 2, but the respective motor control blocks 18 all comprise a pulse generator 22 and a table buffer 24. Thus, providing one table buffer 24 for one motor M furnishes a pulse data value table to a motor M on a one-to-one basis, and enables complete independent control of a plurality of motors M.

Then, in a motor control block 18, pulse data values stored in the table buffer 24 are sequentially transmitted to the pulse generator 22, and the pulse generator 22 generates a motor control signal based on the transmitted pulse data values, and outputs same to the motor M. Thus, data transmission of a pulse data value from the table buffer 24 to the pulse generator 22 is performed without going through the CPU 10, and without being read out each time from an external memory, such as ROM 12 or RAM 14. Further, when a signal is outputted to a motor M, the pertinent signal is provided as feedback, and prompts the pulse generator 22 for the next data transmission. Furthermore, the data transmission of a pulse data value is commenced from an arbitrary buffer address of the table buffer 24, and can be ended at an arbitrary buffer address, and the pulse data value generates an interrupt to the CPU 10 subsequent to data transmission ending.

Furthermore, the motor control unit 16 comprises a reference clock circuit 26 for sending a reference clock for use in generating pulses to the respective pulse generators 22; and a start/stop circuit 28, which controls drive start and stop for a plurality of motors M, that is, the starting and stopping of the operations of the respective pulse generators 22. The reference clock circuit 26 and start/stop circuit 28 are shared by the plurality of motor control blocks 18, and an output signal of the reference clock circuit 26 and an output signal of the start/stop circuit 28 are respectively inputted to the plurality of motor control blocks 18. The reference clock circuit 26 provides a common reference clock for the respective motor control blocks 18. Further, the start/stop circuit 28 is constituted such that when the CPU 10 specifies a motor M, the driving of which is to be either started or stopped, to the start/stop circuit 28, a start/stop signal is sent from the start/stop circuit 28 to the respective motor control blocks 18, and the motor control blocks 18 either start or stop operations based on this signal. The output signal of the start/stop circuit 28 has a bit length equivalent to the number of motors M comprising the motor controller 100, and one motor M (motor control block 18) is allocated for each bit. Then, the motor control blocks 18 corresponding to the respective bits can, simultaneously and independently, be instructed to either start or stop operations by setting either a 1 or a 0 in each bit, and outputting same to the motor control blocks 18.

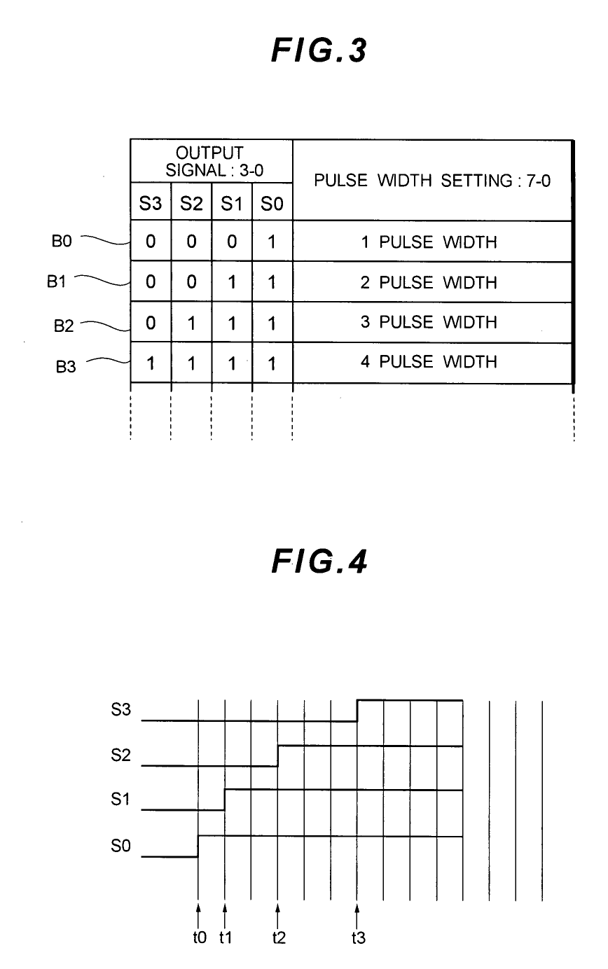

FIG. 3 shows an example of pulse data values stored in a table buffer 24, which is provided separately to the respective motor control blocks 18. A table buffer 24 as shown in FIG. 3 is made up of 1,024 buffers, and each buffer constitutes 12 bits. Of these 12 bits, the most significant 4 bits (the first data) are for instructing the state of an output signal to a motor M (data control signal), and the 0/1 of each bit stipulates the L (low)/H (high) state of the respective output signals. Further, the least significant 8 bits (the second data) are for setting the pulse width, and set the time period during which the state of the motor control signal specified by the most significant 4 bits is outputted (output cycle). Thus, setting the output signal of the most significant 4 bits and the pulse width of the least significant 8 bits makes it possible for a stepping motor M to support a diverse variety of driving.

FIG. 4 shows a motor control signal outputted to a motor M from a pulse generator 22. The pulse generator 22, upon receiving a start command from the start/stop circuit 28, sequentially reads out pulse data values stored in the table buffer 24, and generates and outputs motor control signals. FIG. 4 shows a motor control signal, which is outputted in accordance with table data from buffer 0 to buffer 3 shown in FIG. 3. In this same figure, the time step size expresses the step size of the reference clock. In the diagram shown in FIG. 4, a start command signal is received from the start/stop circuit 28 at time t0, and outputting of motor control signals commences. Firstly, upon receiving a start command signal, a pulse data value stored in buffer B0 of table buffer 24 is transmitted to the pulse generator 22, and the pulse generator 22 generates and outputs to a motor M a one pulse width (a one reference clock) pulse signal (motor control signal) by setting output signal S0 to H, and setting output signals S1, S2, and S3 to L. Then, after the passage of one pulse width of time (time t1), a pulse data value is transmitted to the pulse generator 22 from the subsequent buffer B1, and the pulse generator 22 generates and outputs to a motor M a two pulse width pulse signal by setting output signals S0 and S1 to H, and setting output signals S2 and S3 to L. Thereafter, after the passage of two pulse widths of time (time t2), a pulse data value is transmitted to the pulse generator 22 from buffer B2, and the pulse generator 22 generates and outputs a three pulse width pulse signal by setting output signals S0, S1 and S2 to H, and setting output signal S3 to L. The same processing is repeated thereafter, and the motor control block 18 sequentially transmits pulse data values stored in the table buffer 24 to the pulse generator 22, and generates and outputs to a motor M pulse signals based on the pulse data values transmitted by the pulse generator 22. Then, the pulse generator 22 repeats motor control signal generation/output processing until a stop signal is received from the start/stop circuit 28.

It is desirable that the table buffer 24 in this embodiment have a ring buffer configuration, which stores and manages data in a ring shape by linking together the beginning and end of a storage array. By using a ring buffer configuration, it becomes possible to set infinite length pulse data, enabling the infinite driving of a motor M. Further, it is possible to reduce the buffer size, leading to cost reductions as well.

Further, the table buffer 24 is constituted so as to be able to output an interrupt to the CPU 10 in a buffer empty near end or buffer end, which show that buffer end is approaching. Consequently, since the timing at which a buffer becomes empty can be notified to the CPU 10, the CPU 10 can write the pulse data values stored in either ROM 12 or RAM 14 to the table buffer 24 prior to the buffer becoming empty. Write (rewrite) timing can be decided by the processing speed of the CPU 10 or the size of the table buffer 24.

Furthermore, a function for reading out a buffer address that is currently being read out (being transmitted to the pulse generator 22) can be provided in the table buffer 24. Consequently, since the CPU 10 is able to ascertain the pulse data value up to which outputting has been carried out, it is possible to set subsequent data in a location for which pulse data value transmission is complete.

Further, instead of making the table buffer 24 a ring buffer configuration, the table buffer 24 can be a double buffer configuration, which alternately uses two storage arrays. Since using a double buffer configuration makes it possible to write a pulse data value to the one storage array while reading a pulse data value from the other storage array, motor M drive control can be carried out seamlessly.

An overview of the operation of a motor controller 100 constituted as described hereinabove will be explained.

First, the CPU 10 reads out from either ROM 12 or RAM 14 tables of pulse data values corresponding to the operating patterns of the respective motors M, and writes same to the table buffers 24, which are provided corresponding one-to-one with the respective motors M. When the plurality of motors M are subjected to drive control using respectively different operating patterns at this time, respectively different pulse data value tables are written to the respective table buffers 24. Then, when the CPU 10 specifies to the start/stop circuit 28 the motor M for which driving is to be commenced, a start signal is sent from the start/stop circuit 28 to the prescribed motor control block 18, and the motor control block 18 starts operation on the basis of this signal.

When the motor control block 18 starts operation, pulse data values are sequentially transmitted to the pulse generator 22 from the table buffer 24, and pulse signals indicated by the transmitted pulse data values are generated and outputted to the motor M. Thereafter, except for when the table buffer 24 is rewritten, data transmissions to the pulse generator 22 from the table buffer 24, and the generation and outputting of motor control signals, are carried out without going through the CPU 10. Furthermore, when the table buffer 24 detects a buffer empty near end or the like, the CPU 10 is notified, and the table of pulse data values in the table buffer 24 is rewritten.

When the driving of a motor M is to stop, the CPU 10 issues a command to the start/stop circuit 28 to stop driving the prescribed motor M. On the basis of this command, a stop signal is sent from the start/stop circuit 28 to the prescribed motor control block 18, and the motor control block 18 stops operation on the basis of this signal.

As described hereinabove, a motor controller of an aspect of the invention respectively provides table buffers 24 to a plurality of motor control blocks 18, making possible one-to-one data storage for the motors M and completely independent driving. Consequently, drive start and stop can simultaneously be controlled for a plurality of motors M.

Furthermore, the invention is not limited to the above-described embodiment, and can be put into practice in a variety of other forms within a scope that does not deviate from the gist of the invention. Thus, the above-described embodiment in all respects is simply an example, and is not a restrictive interpretation.

For example, it is possible to either arbitrarily change the order of the operation overview described hereinabove in a scope that does not contradict the contents of the processing, or to execute same in parallel.

What is claimed is:

1. A motor controller which controls the driving of a plurality of motors, comprising for each of the plurality of motors:
a motor control block for independently controlling the driving of the respective motors,
wherein the respective motor control blocks comprises:
a storage unit that stores a pulse data value for generating a signal for carrying out drive control of a motor which is connected to this motor control block; and
a pulse generator that generates the signal for carrying out drive control of the motor based on pulse data values sequentially transmitted from the storage unit, and outputs same to the motor connected to this motor control block.

2. The motor controller according to claim 1, wherein a plurality of motor control blocks share a start/stop unit that controls drive start and stop for a plurality of motors, enabling the motor controller to simultaneously control drive start and stop for the plurality of motors.

3. The motor controller according to claim 1, wherein the storage unit is a ring buffer configuration, which links the beginning and end of a storage array to store and manage data in a ring shape, and is capable of setting infinite length pulse data.

4. The motor controller according to claim 1, wherein the storage unit is a double buffer configuration having two storage arrays, enabling a pulse data value to be written to the one storage array while a pulse data value is being read from the other storage array.

5. The motor controller according to claim 1, further comprising a controller that controls the overall operation of the motor controller,
wherein the storage unit has a function for outputting either an empty near end or an end interrupt, and for notifying the controller of the timing at which the storage unit becomes empty, and
the controller, upon receiving either the empty near end or the end interrupt from the storage unit, carries out pulse data value rewriting for the storage unit.

6. The motor controller according to claim 1, further comprising a controller that controls the overall operation of the motor controller,
wherein the storage unit has a function for reading an address which is currently being read out, and
the controller carries out rewriting of an outputted pulse data value for the storage unit based on an address received from the storage unit.

7. The motor controller according to claim 1, wherein the motor is a stepping motor, and
the pulse data value includes first data for prescribing the states of signals outputted to the respective motors, and second data for prescribing the pulse width of output signals.
